(19) United States
(12) Patent Application Publication
(10) Pub. No.: US 2018/0034743 A1
(43) Pub. Date: Feb. 1, 2018

(54) SYSTEM FOR DISTRIBUTION OF UNUSED OR UNDERUSED RESOURCES

(71) Applicant: BANK OF AMERICA CORPORATION, Charlotte, NC (US)

(72) Inventors: Katherine Dintenfass, Lincoln, RI (US); Victoria L. Dravneek, Charlotte, NC (US); Cameron D. Wadley, Waxhaw, NC (US); Jason Christian Karmelek, Mendon, MA (US); Amber J. Quitadamo, Woodstock, GA (US)

(21) Appl. No.: 15/219,642

(22) Filed: Jul. 26, 2016

(51) Int. Cl. H04L 12/923; H04L 12/24

(52) U.S. Cl. CPC H04L 47/762; H04L 41/12

(57) ABSTRACT

The invention implements a distributed computing network to identify or detect resources that are being unused and/or underused and, in response to such identification, reallocating the resources. In this regard, reallocation may provide for aggregating and/or converting the resources to another resource or transferring the resource to another entity, which may include converting the resource to another resource prior to transfer.

### FIELD OF THE INVENTION

The present invention related to data communication amongst a system of interrelated computing devices and, more specifically, systems and the like that identify unused or underused resources and, in response to identifying reallocate the resources, such as transferring the resources to another entity or aggregating and/or converting the resources to another resource.

### BACKGROUND

In many instances resources that are generated and provided to an entity often go unused or underused because the entity to which the resources are provided have no need for the resource.

Therefore, a need exists to identify resources that have been provided to an entity, which are unused or underused and, in response to identify such resources, reallocate the resources. In this regard, a needs exists to either aggregate and/or convert the resources into a another resource that the entity will utilize, or transfer (and in some instances convert) the unused/underused resource to another entity that has a need for the resource.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program products, identifying resources provided to an entity that are being unused and/or underused by the entity and, in response to such identification, reallocating the resources. In this regard, reallocation may provide for aggregating and/or converting the resources to another resource that is needed by the entity or transferring the resource to another entity that has a need for the resource, which may include converting the resource to another resource more beneficial to the other entity.

A system for enhancing distribution of resources defines first embodiments of the invention. The system includes a plurality of computing devices disposed across a distributed communication network each of the devices comprising a computer platform including, a memory and at least one processor in communication with the memory. The system additionally includes a resource generator module stored in the memory of at least one of the computing devices, executable by the processor of the at least one computing device and configured to generate one or more resources for an entity in response to occurrence of an entity-related triggering event. Additionally, the system includes a resource utilization module stored in the memory of at least one of the computing devices, executable by the processor of the at least one computing device and configured to identify, from the one or more resources generated for the entity, at least one resource that is unused or underused by the entity. Moreover, the system includes a resource reassignment module stored in the memory of at least one of the computing devices, executable by the processor of the at least one computing device and configured to reassign the at least one unused resource or underused resource.

In specific embodiments of the system, the resource reallocation module further includes a resource conversion sub-module that is configured to convert the at least one unused resource or underused resource to at least a portion of a secondary resource. In such embodiments of the system, the resource conversion sub-module is further configured to aggregate the unused resources or underused resources prior to converting unused resources or underused resources to the secondary resource.

In other specific embodiments of the system, the resource reallocation module further includes a resource transfer sub-module that is configured to electronically transfer the unused resource or underused resource to another entity identified by the entity. In related embodiments of the system, the resource transfer sub-module further includes a resource conversion routine that is configured to convert the unused resource or underused resource to a secondary resource associated with the other entity prior to transferring the unused resource or underused resource to another entity.

In still further specific embodiments of the system, the resource utilization module is further configured to provide information on the identified unused resources and underused resources to the resource generator module and, in such embodiments, the resource generator module is configured to receive and use the information in determining which resources should be generated for the entity in response to occurrence of a future triggering event.

In other specific embodiments of the system, the resource utilization module is further configured to identify the at least one resource that is unused or underused by the entity by one of (i) lapse of the resource or (ii) an entity input that indicates that the resource will not be used or will not be used in total.

Additionally, in other specific embodiments of the system, the resource utilization module is further configured receive entity inputs that rate the resource and other resources, wherein the rating of the resource is used to identify the at least one resource that is unused or underused by the entity. In related embodiments of the system, the resource generator module is configured to receive the rating of the other resources and use the ratings of the other resources in determining which resources should be generated for the entity in response to occurrence of a future triggering event.

In still further specific embodiments of the system, the resource generator module is configured to generate one or more rewards providing to the entity in response to a positive behavior conducted by the entity. In such embodiments of the invention, the resource reallocation module includes a resource conversion sub-module that is configured to convert unused rewards or underused rewards to at least a portion of a secondary reward that the entity has indicated is useful. In further related embodiments of the system, the resource conversion sub-module is configured to aggregate unused rewards or underused rewards prior to converting the unused rewards or underused rewards to the at least a portion of a secondary reward. In other specific embodiments of the system, the resource reallocation module includes a resource transfer sub-module that is configured to electronically transfer unused rewards or underused rewards to another entity identified by the entity. In still further related embodiments of the system, the resource transfer sub-module further comprises a resource conversion routine that is configured to convert the unused reward or underused rewards to a secondary resource useful to the other entity prior to transferring the unused rewards or underused reward to another entity, wherein the secondary resource of a different type of form than the unused reward or underused reward.

A method for enhancing distribution of resources defines second embodiments of the invention. The method includes providing for a plurality of computing devices disposed across a distributed computing network. In addition, the method includes generating, at one or more of the computing devices, one or more resources for an entity in response to occurrence of an entity-related triggering event and identifying, by at least one computing device processor associated with a corresponding one of the computing devices, at least one of the one or more resources that is unused or underused by the entity. Additionally, the method includes, in response to identifying the at least one unused resource or underused resource, reallocating, by at least one computing device processor associated with a corresponding one of the computing devices, the at least one unused resource or underused resource.

In further specific embodiments of the method, reallocating further includes converting, by a computing device processor, the at least one unused resource or underused resource to at least a portion of a secondary resource. In related embodiments of the method, converting further includes aggregating the unused resources or underused resources prior to converting the unused resources or underused resources to the secondary resource.

In other specific embodiments of the method, reallocating further includes transferring, via a computing network, the unused resource or underused resource to another entity identified by the entity.

A computer program product for analyzing enhancing distribution of resources defines third embodiments of the invention. The computer program product includes a non-transitory computer-readable storage medium having computer-executable instructions. The instructions are operable for generating, at one or more of computing devices disposed across a distributed computing network, one or more resources for an entity in response to occurrence of an entity-related triggering event, In addition, the instructions are operable for identifying at least one of the one or more resources that is unused or underused by the entity, and, in response to identifying the at least one unused resource or underused resource, reallocating the at least one unused resource or underused resource.

In specific embodiments of the computer program product, the instructions operable for reallocating the at least one unused resource or underused resource further include instructions for at least one of converting the at least one unused resource or underused resource to at least a portion of a secondary resource or transferring the least one unused resource or underused resource to another entity identified by the entity.

Thus, systems, apparatus, methods, and computer program products herein described in detail below provide for identifying resources provided to an entity that are being unused and/or underused by the entity and, in response to such identification, reallocating the resources. In this regard, reallocation may provide for aggregating and/or converting the resources to another resource that is needed by the entity or transferring the resource to another entity that has a need for the resource, which may include converting the resource to another resource more beneficial to the other entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a schematic diagram of an exemplary system for enhancing distribution and reallocation of resources, in accordance with embodiments of the present invention;

FIG. 2 provides a block diagram of an apparatus for enhancing distribution and reallocation of resources, in accordance with embodiments of the present invention;

FIG. 3 provides a block diagram of an apparatus for enhancing distribution and reallocation of rewards, in accordance with embodiments of the present invention; and

FIG. 4 provides a flow diagram of a method system for enhancing distribution and reallocation of resources, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Many of the embodiments and example implementations thereof described herein are directed toward solving a pervasive technical problem that consumers at all levels, from individuals to global enterprises, have suffered without reprieve, namely, that the reallocation of unused or underused resources.

In accordance with embodiments of the present invention, resources are generated for an entity and, subsequently the one or more of the resources provided to an entity are identified or detected as being unused and/or underused. In response to such identification, the resources are reallocated. In this regard, reallocation may provide for aggregating and/or converting the resources to another resource that is needed by the entity or transferring the resource to another entity that has a need for the resource, which may include converting the resource to another resource more beneficial to the other entity.

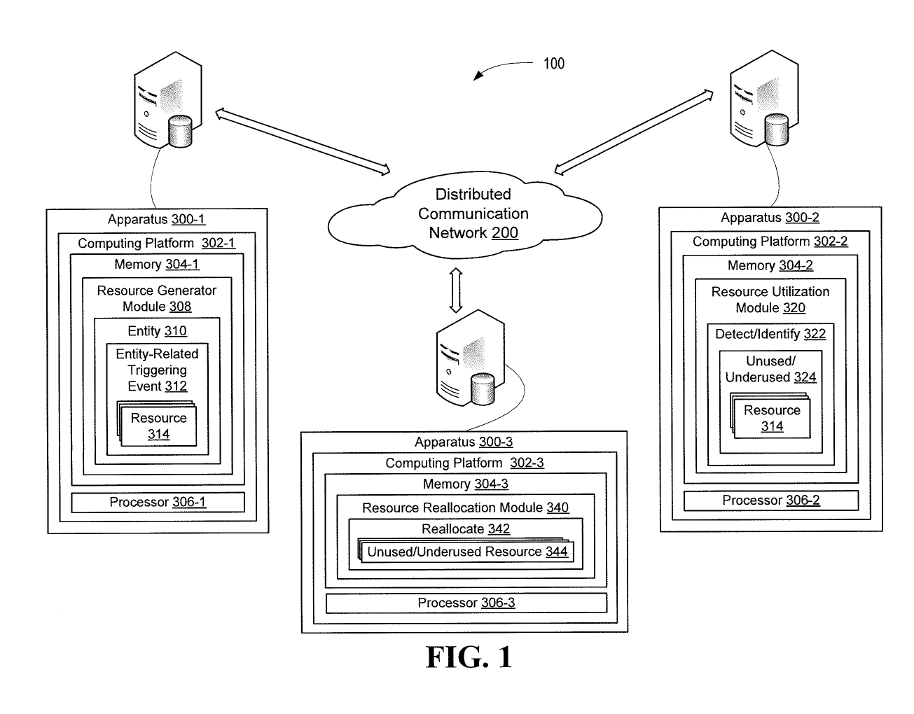

Referring to FIG. 1, a schematic diagram is provided of a system 100 for enhancing distribution and reallocation of resources, in accordance with embodiments of the present invention. The system 100 is implemented in a distributed communication environment via computing network 200, which typically comprises an intranet and/or the Internet. System 100 includes apparatus 300-1 which may comprise one or more computing devices. As such, apparatus 300-1 includes a computing platform 302-1 having a memory 304-1 and at least one processor 306-1 in communication with the memory. Memory 304-1 stores resource generator module 308 that is executable by the processor 306-1 and configured to generate one or more resources for an entity 310 in response to an entity-related triggering event 312. In specific embodiments of the invention, discussed infra., the entity-related triggering event 312 that results in generation of the resource 314 is a behavior by the entity 314 that is preferred by the resource generator.

The system 100 additionally includes apparatus 300-2 which may comprise one or more computing devices. As such, apparatus 300-2 includes a computing platform 302-2 having a memory 304-2 and at least one processor 306-2 in communication with the memory. Memory 304-2 stores resource utilization module 320 that is executable by the processor 306-2 and configured to identify/detect 322 that one or more of the resources 314 and unused/underused 324. In specific embodiments of the invention, the resource 314 may be identified as unused or underused based on lapse of a predetermined resource expiration date. For example, the module 320 may determine that all or a portion of the resource 314 remains unused at the predetermined resource expiration data. In other embodiments of the invention, the module 320 may be configured to receive an entity input that indicates the unwillingness of the entity to use all or a portion of the resource 314.

Additionally, the system 100 includes apparatus 300-2 which may comprise one or more computing devices. As such, apparatus 300-2 includes a computing platform 302-2 having a memory 304-2 and at least one processor 306-2 in communication with the memory. Memory 304-2 stores resource utilization module 320 that is configured to, in response to identifying/detecting an unused/underused resource 344, reallocate 342 the unused/underused resource 344. Reallocation may include aggregating and/or converting the resource 314 to another secondary resource that is needed by the entity 310. In other embodiments of the invention, reallocation may include transferring the resource 314 to another entity that has a need for the resource or converting the resource to another secondary resource prior to the transfer to the other entity.

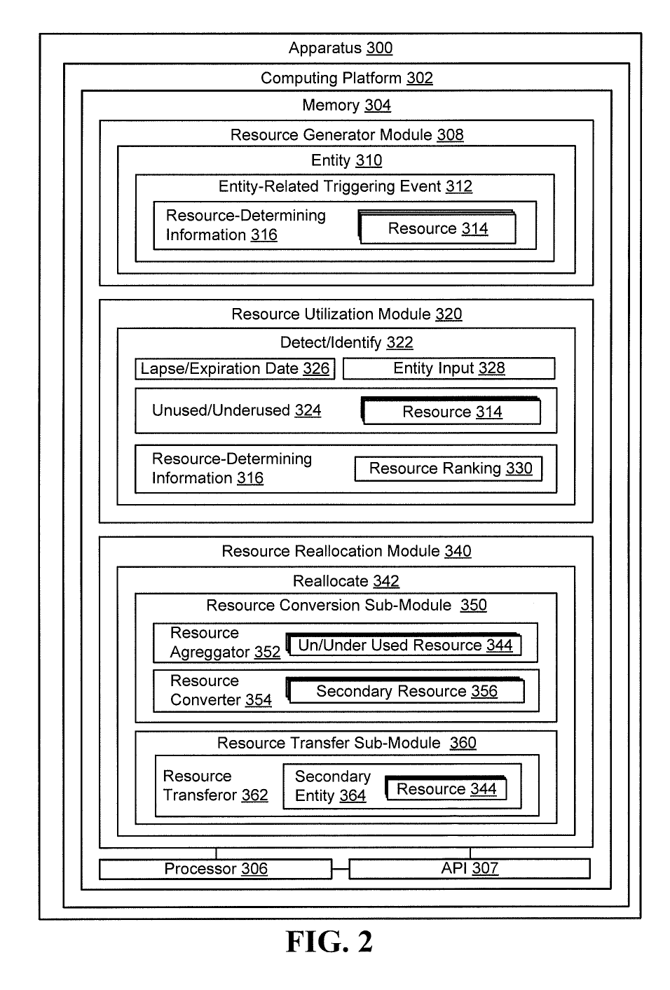

Referring to FIG. 2 a block diagram is presented of the apparatus 300, which is configured for determining enhanced distribution and reallocation of resources, in accordance with embodiments of the present invention. In addition to providing greater detail, FIG. 2 highlights various alternate embodiments of the invention. The apparatus 300 may include one or more of any type of computing device, such as one or more servers, personal computers or the like. The present apparatus and methods can accordingly be performed on any form of one or more computing devices.

The apparatus 300 includes a computing platform 302 that can receive and execute algorithms, such as routines, and applications. Computing platform 302 includes memory 304, which may comprise volatile and non-volatile memory, such as read-only and/or random-access memory (RAM and ROM), EPROM, EEPROM, flash cards, or any memory common to computer platforms. Further, memory 304 may include one or more flash memory cells, or may be any secondary or tertiary storage device, such as magnetic media, optical media, tape, or soft or hard disk. Moreover, memory 304 may comprise cloud storage, such as provided by a cloud storage service and/or a cloud connection service.

Further, computing platform 302 also includes processor 306, which may be an application-specific integrated circuit (“ASIC”), or other chipset, processor, logic circuit, or other data processing device. Processor 306 or other processor such as ASIC may execute an application programming interface (“API”) 307 that interfaces with any resident programs, such as resource generator module 308, resource utilization module 320 and resource reallocation module 330 and routines, sub-modules associated therewith or the like stored in the memory 404 of the apparatus 400.

Processor 306 includes various processing subsystems (not shown in FIG. 2) embodied in hardware, firmware, software, and combinations thereof, that enable the functionality of apparatus 300 and the operability of the apparatus 300 on a network 200. For example, processing subsystems allow for initiating and maintaining communications and exchanging data with other networked devices, such as those apparatus 300 shown in FIG. 1. For the disclosed aspects, processing subsystems of processor 306 may include any subsystem used in conjunction with resource generator module 308, resource utilization module 320 and resource reallocation module 330 and related algorithms, sub-algorithms, modules, sub-modules thereof.

Computer platform 302 may additionally include communications module (not shown in FIG. 2) embodied in hardware, firmware, software, and combinations thereof, that enables communications among the various components of the apparatus 300, as well as between the other networked devices. Thus, communication module may include the requisite hardware, firmware, software and/or combinations thereof for establishing and maintaining a network communication connection.

The memory 304 of apparatus 300 stores resource generator module 308 which is configured to generate and initiate communication of resources 314 to a designated entity 310 in response to an entity-related triggering event 312. In specific embodiments of the invention, the entity-related triggering event 312 may be based on the behavior preferred by the entity bestowing the resource 314. In additional embodiments of the invention, the resource may be an entity-specific or entity-targeted resource based on resource-determining information 316. In such embodiments of the invention, the resource-determining information 316 may be information from data sources accessible to the entity bestowing the resource and/or the information may be based on feedback/information provided by the resource detection module 320, discussed in detail infra.

Further, the memory 304 of apparatus 300 stores resource utilization module 320 that is configured to detect/identify 322 that a resource 314 is being unused/underused 324. In specific embodiments, in which the resources 314 are associated with a predetermined lapse/expiration date 326, the module 320 is configured to automatically detect/identify 322 a resource 314 as being unused/underused based on at least a portion of the resource remaining unused upon lapse (i.e., upon meeting or exceeding the expiration date). In other embodiments of the invention, the module 320 is configured to receive an entity input 328 that indicates an unwillingness to use at least a portion, if not all, of the resource. In such embodiments of the invention, the module 320 may be configured to provide for the entity input via a resource portal (not shown in FIG. 2) that is configured to display current resources associated with the entity or the communication provided to the entity that notifies the entity of the resource may be configured for a reply communication that notifies the resource-bestowing entity of the unwillingness of the entity to use the resource 314 and/or use at least a portion of the resource 314.

In addition, module 320 may be configured to capture resource-determining information 316 and communicate such information 316 to the resource generator module 308 for the purpose of using such information to provide the entity with future resources that are more entity-specific (i.e., targeted for the entity). In specific embodiments of the invention, resource-determining information 316 may comprise information on which resources 314 have been identified as being unused and/or unused, such that, future resources generated for the entity are not the same resource and/or not the same resource type or classification. In other specific embodiments of the invention, the resource-determining information 316 may comprise resource ranking 330 information. In such embodiments of the invention, the module 320 may be configured to receive resource ranking 330 from the entity 310 via a resource portal (not shown in FIG. 2) that is configured to display current resources 314 associated with the entity 310 and allow for the entity to rank the resource in terms of likelihood of use or the communication provided to the entity that notifies the entity of the resource 314 may be configured for a reply communication that indicates the entity's ranking of the resource 314 associated with the notification.

In addition, the apparatus 300 includes resource reallocation module 340 which is configured to, in response to identification/detection of an unused/underused resource 344, reallocate 342 the unused/underused resource 344. In specific, embodiments of the invention, the resource reallocation module 340 includes resource conversion sub-module 350 that includes resource converter 354 configured to convert the unused/underused resource 344 to secondary resource 356 that is needed/sought by the entity 310. In this regard, resource converter 354 is configured to determine which resource(s) that the entity needs based on entity inputs or ancillary information associated with the entity (e.g., resource-determining information 316 received from the resource utilization module 320 or from other data sources accessible to the resource converter 354. In such embodiments of the invention, the resource conversion sub-module 350 may include resource aggregator 352 that aggregates the unused/underused resources 344 prior to conversion (or in some embodiments of the invention, the resource aggregator 352 aggregates the secondary resources 356 after conversion)

In other embodiments of the apparatus, the resource reallocation module 340 includes resource transfer sub-module 350 that includes resource transferor 362 that is configured to transfer the unused/underutilized resource 344 to a secondary entity 364 that has a need for the resource. In specific embodiments of the apparatus, the entity/transferor may provide inputs that identify the transferee. The transferee that is identified may be specific to resource type, resource amount/volume, time/date of transfer or the like. In addition, the resource transfer sub-module 360 may include a resource converter (not shown in FIG. 2) that is configured to convert the unused/underused resource 344 to a secondary resource that is desired by the secondary entity prior to transferring the resource to the secondary entity 344. In such embodiments of the apparatus, the resource transfer sub-module 360 may be configured to provide for the entity or the secondary entity to make inputs that identify the secondary resource needed/sought by secondary entity 364.

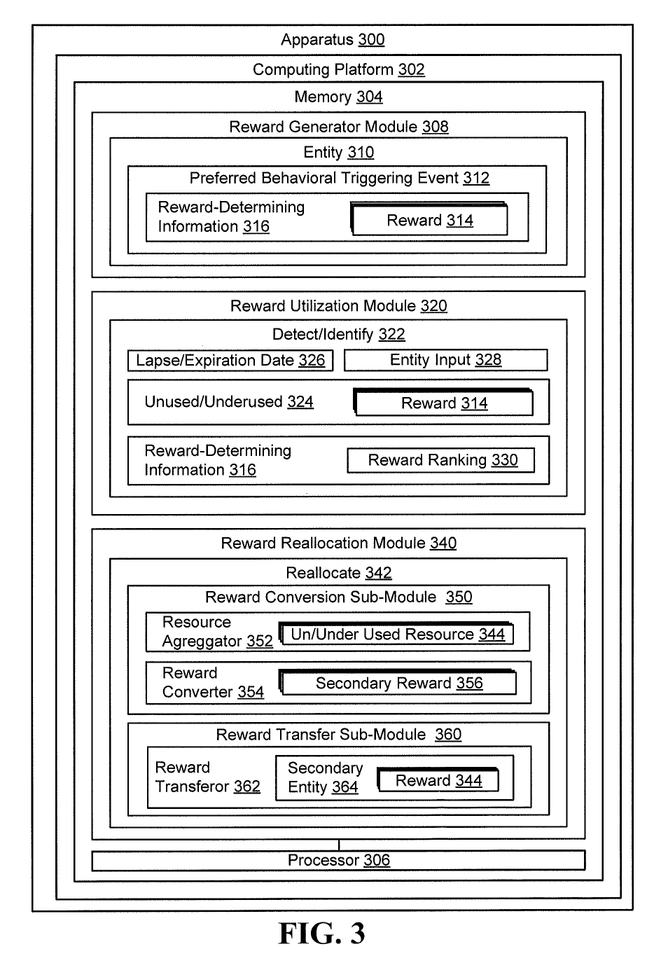

Referring to FIG. 3 a block diagram is shown of an apparatus 300 for enhanced distribution and reallocation of resources, in accordance with embodiments of the present invention. In accordance with the embodiments shown and discussed in relation to FIG. 3, the resource is characterized as a reward that may be bestowed upon an entity, such as a customer and, in specific embodiments of the invention, a financial institution customer. Similar to the apparatus shown and discussed in FIGS. 1 and 2, the apparatus 300 of FIG. may comprise one or more computing devices and includes a computing platform 302 having a memory 304 and at least one processor 306 in communication with the memory.

The memory 304 of apparatus 300 stores rewards generator module 308 that is configured to generator one or more rewards 314 for an entity 312 (i.e., reward recipient) in response to a preferred behavior triggering event 312. In specific embodiments of the invention the reward may be points for a point-based rewards system, a coupon or gift certificate associated with a merchant or any other offer associated with a merchant or the like. In those embodiments in which the reward 314 is being bestowed by a financial institution, the preferred behavior triggering event 312 may be any event associated with attaining a financial goal, such as, but not limited to, opening a savings account; setting up direct deposit of a paycheck; setting up automated bill pay or the like. In other embodiments of the invention, the reward may be generated based on any action taken by the entity that assists or aids the entity bestowing the reward, such as but not limited to, referring someone to the entity bestowing the reward, transferring an unused/underused reward to another entity (i.e., friend, family member or the like). In other embodiments of the invention the entities 310 may be classified by the entity bestowing the rewards, such that higher classifier or preferred entities may earn rewards at a greater rate or earn higher rewards.

In further specific embodiments of the invention, the rewards 314 that are generated may be based on entity-specific reward-determining information 316. By determining/generating rewards 314 based on the entity-specific reward-determining information 316, the rewards are more targeted for the entity in terms of what the entity needs or otherwise would prefer. In this regard, the more targeted (i.e., entity-specific) the reward is, the less likely the reward will be unused or underused by the entity. The reward-determining information 316 may be information received from the reward utilization module 320 including notification of rewards 314 that are unused or underused, rewards rankings/ratings received from the entity (i.e., reward recipient) or the like. In other embodiments of the invention, the reward-determining information 316 may be other entity-specific information that is accessible to the entity bestowing the reward 314. For example, the reward-determining information 316 may be entity profile information, entity transaction history or any other information that may be advantageous to determining the interests of the entity (i.e., what types of rewards the entity may be interested in receiving).

The memory 304 of apparatus 300 additionally stores reward utilization module 320 that detects or otherwise identifies a reward 314 that is unused/underused 324 by the entity 310. As previously discussed, the reward may have a predetermined expiration/lapse date 326 associated therewith, such that once the expiration/lapse date 326 has been exceeded and the reward has not been used (e.g., redeemed) or underused (e.g., a portion of the reward remains), the reward is detected to be unused/underused 324. In other embodiments of the invention, the entity (i.e., reward recipient) may provide an entity input 328 that indicated their unwillingness to use the reward or at least a portion of the reward. In specific embodiments, in which the reward is communicated to the entity electronically (e.g., via email, text or the like) the electronic notification of the rewards may be configured to allow the entity to respond to the notification (i.e., entity input 328) with an indication that the entity will not be using the rewards or will not be using the reward in its entirety. In other specific embodiments of the invention, the module 320 may be associated with a portal, such as an online merchant portal (e.g., online banking website portal or the like) that provides for the entity 310 to view outstanding rewards and to provide an entity input 328 that rejects a rewards or otherwise indicated that the entity 310 will not be using the reward 314 or will not be using the reward 314 in its entirety. In addition, the electronic notification of the reward 314 and/or the portal may be configured for reward ranking 330, which allows the entity to rank or otherwise rate the reward in terms of how desirable the reward 314 is to the entity 310 and/or the likelihood that the entity 310 will use the reward 314. As previously discussed, the indication that the reward 314 is not being used/underused 324 and/or the reward ranking 330 may form reward-determining information 316 that is communicated to the reward generator module 320 and/or the rewards allocation module 320 for subsequent determination and generation of or conversion to more targeted user-specific rewards 314.

Memory 304 of apparatus 300 also includes rewards reallocation module 340 that is configured to, in response to receiving notification of an identified/detected unused/underused reward 344. Reallocate 342 the unused/underused reward 344. In specific embodiments of the invention, the rewards reallocation module 340 includes reward conversion sub-module 350 that includes reward convertor 354 that is configured to convert the unused/underused reward to a secondary reward that is more desirable to the entity 310. In such embodiments of the invention, the reward conversion sub-module may rely on entity inputs, the reward-determining information 316 and or other entity-related data sources accessible to the reward reallocation module 340, such as profile databases, transaction history databases and the like. In other embodiments of the invention, the reward conversion sub-module 350 may include a reward aggregator 352 that is configured to aggregate unused/underused rewards 344 prior to converting the reward to the secondary reward 356. For example, unused rewards points for a points-based rewards program may be aggregated for the purpose of reaching a point total associated with a major (e.g., high point total) reward desired by the entity, once the point total is achieved (through aggregation of unused/underused points) the point total is converted to the reward. In another example, rewards points may be aggregated to provide for a different type of reward, smaller cash-back or percentage-off offers may be aggregated to provide for higher cash-back or percentage—off offers or the like. In other embodiments of the invention, the reward aggregator 352 may be implemented after the rewards 344 have been converted to the secondary reward 356 (i.e., the secondary rewards may be aggregated to result in an accumulated secondary reward).

The reward reallocation module 340 may additionally comprise reward transfer sub-module 350 that includes rewards transferor 362 that is configured to transfer the unused/underutilized resource 344 to a secondary entity 364 (i.e., a friend or a family member) that has a need/desire for the resource. In specific embodiments of the apparatus, the entity/transferor 310 may provide inputs that identify the transferee (i.e., the secondary entity 364). The transferee that is identified may be specific to resource type, resource amount/volume, time/date of transfer or the like.

In addition, the reward transfer sub-module 350 may be used in conjunction with the reward conversion sub-module 350 such that the unused/underused rewards 344 are converted to a desired reward of the secondary entity 364 prior to transferring the reward to the secondary entity 364. In such embodiments of the invention, the entity 310 may become aware of the needs/desires of the secondary entity through a rewards/goal publicizer module (not shown in FIG. 3) that serves to publicize an entity's goals and/or reward needs/desires. In this regard, the publicizer module may provide for an entity-accessible portal that provides a searchable database of an entity's goals and/or reward needs/desires (e.g., savings for college, saving for new car, need a vacation, and the like). In other embodiments of the invention, the publicizer module may communicate notifications to other entities (i.e., friends and family or the like) indicating the other entity's goals and/or reward needs/desires or interact with an entity's social media to post indication of the other entity's goals and/or reward needs/desires.

Once the unused/underused reward 344 has been transferred to the secondary entity 364 or converted and transferred to the secondary entity 364 the secondary entity may receive electronic notification (e.g., email, text message or the like) of the transfer.

In addition, once the transfer of the reward has been completed, the entity/transferee 314 may receive a rewards (e.g., points or the like) for transferring the reward, which may trigger the reward generator module 308 to generate and initiate communication of a new reward 314 to the entity 310.

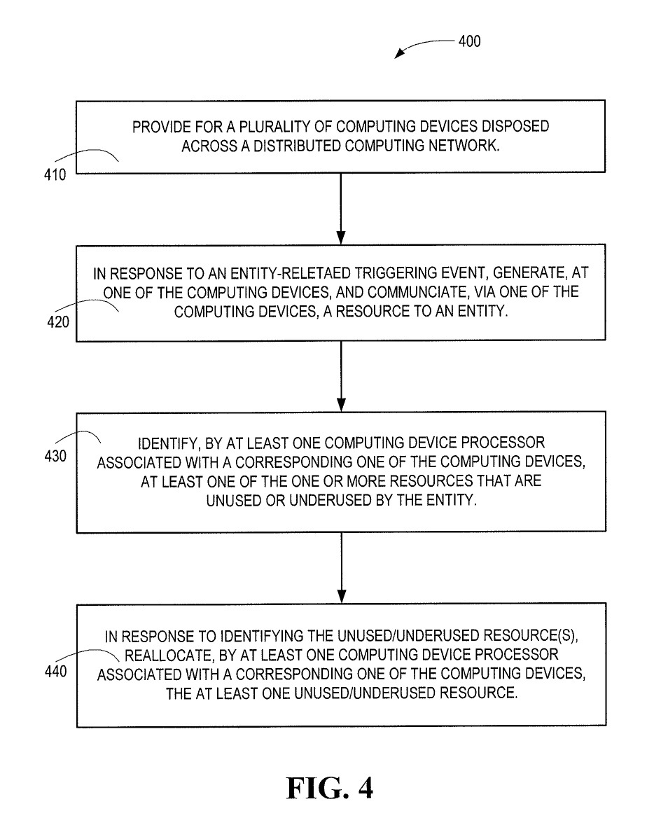

Referring to FIG. 4 a flow diagram is depicted of a method 400 for enhancing distribution and reallocation of resources, in accordance with embodiments of the present invention. At Event 410, a plurality of communication devices are disposed across a distributed communication network, such as an intranet, the Internet, a combination of an intranet and the Internet or the like.

At Event 420, in response to an entity-related triggering event, one of the computing devices generates and initiates communication of a resource to an entity. In specific embodiments of the method, in which the resource is a reward (e.g., points for a points-based rewards program, offers, discounts, tangible items, services or the like), the entity-related triggering event may be a behavior performed by the entity or the like. Moreover, the reward may be determined based on feedback from the entity (e.g., reward ratings/rankings, notification of unwillingness to use a reward or the like), entity profiles or other entity-related data sources accessible to the entity bestowing the reward.

At Event 430, at least one of the resources generated and provided to the entity are identified or detected, by one of the computing devices, as being (or will be) unused or underused by the entity. In specific embodiments, such identification detection may coincide with lapse/expiration of the resource or, in other embodiments of the invention, an entity input may indicate that the resource has not and/or will not be used or will be underused (i.e., only a portion of the resource has been or will be used). Such entity input may include ranking/rating the resource. Such indication that the resource will not be used or will be underused and/or the resource ranking/rating may be fed back to the resource generator (Event 420), such that subsequent generation of rewards are more targeted to the needs/desires of the entity.

At Event 440. In response to identifying/detecting a resource as being unused/underused, the resource is reallocated by one of the processors associated with one of the computing devices. Reallocation may include converting the resource to another secondary resource that is needed by or more desired by the entity. Conversion may include aggregating unused/underused resources prior to, or in some embodiments after, conversion of the resource to the secondary resource. In other embodiments of the invention, reallocation may include transferring the unused/underused resource to a secondary resource that has a need for the unused/underused resource. In related embodiments, the unused/underused resource may be converted to a resource more needed/desirable to the secondary entity prior to transferring the resource to the secondary entity.

Thus, systems, apparatus, methods, and computer program products described above provide for detecting or identifying resources provided to an entity that are being unused and/or underused by the entity and, in response to such identification, reallocating the resources. In this regard, reallocation may provide for aggregating and/or converting the resources to another resource that is needed by the entity or transferring the resource to another entity that has a need for the resource, which may include converting the resource to another resource, more beneficial to the other entity, prior to transferring.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for enhancing distribution of resources, the system comprising:
a plurality of computing devices disposed across a distributed communication network each of the devices comprising a computer platform including, a memory and at least one processor in communication with the memory;
a resource generator module stored in the memory of at least one of the computing devices, executable by the processor of the at least one computing device and configured to generate one or more resources for an entity in response to occurrence of an entity-related triggering event;
a resource utilization module stored in the memory of at least one of the computing devices, executable by the processor of the at least one computing device and configured to identify, from the one or more resources generated for the entity, at least one resource that is unused or underused by the entity; and
a resource reallocation module stored in the memory of at least one of the computing devices, executable by the processor of the at least one computing device and configured to reallocate the at least one unused resource or underused resource.

2. The system of claim 1, wherein the resource reassignment module further comprises a resource conversion sub-module that is configured to convert the at least one unused resource or underused resource to at least a portion of a secondary resource.

3. The system of claim 2, wherein the resource conversion sub-module is further configured to aggregate the unused resources or underused resources prior to converting unused resources or underused resources to the secondary resource.

4. The system of claim 1, wherein the resource reassignment module further comprises a resource transfer sub-module that is configured to electronically transfer the unused resource or underused resource to another entity identified by the entity.

5. The system of claim 4, wherein the resource transfer sub-module further comprises a resource conversion routine that is configured to convert the unused resource or underused resource to a secondary resource associated with the other entity prior to transferring the unused resource or underused resource to another entity.

6. The system of claim 1, wherein the resource utilization module is further configured to provide information on the identified unused resources and underused resources to the resource generator module and, wherein the resource generator module is configured to use the information in determining which resources should be generated for the entity in response to occurrence of a future triggering event.

7. The system of claim 1, wherein the resource utilization module is further configured to identify the at least one resource that is unused or underused by the entity by one of lapse of the resource or an entity input that indicates that the resource will not be used or will not be used in total.

8. The system of claim 1, wherein the resource utilization module is further configured receive entity inputs that rate the resource and other resources, wherein the rating of the resource is used to identify the at least one resource that is unused or underused by the entity.

9. The system of claim 8, wherein the resource generator module is configured to receive the rating of the other resources and use the ratings of the other resources in determining which resources should be generated for the entity in response to occurrence of a future triggering event.

10. The system of claim 1, wherein the resource generator module is configured to generate one or more resources for an entity in response to occurrence of an entity-related triggering event, wherein the resources are rewards providing to the entity and wherein the triggering event is a positive behavior conducted by the entity.

11. The system of claim 10, wherein the resource reassignment module includes a resource conversion sub-module that is configured to convert unused rewards or underused rewards to at least a portion of a secondary reward that the entity has indicated is useful.

12. The system of claim 11, wherein the resource conversion sub-module is configured to aggregate unused rewards or underused rewards prior to converting the unused rewards or underused rewards to the at least a portion of a secondary reward.

13. The system of claim 10, wherein the resource reassignment module includes a resource transfer sub-module that is configured to electronically transfer unused rewards or underused rewards to another entity identified by the entity.

14. The system of claim 10, wherein the resource transfer sub-module further comprises a resource conversion routine that is configured to convert the unused reward or underused rewards to a secondary resource useful to the other entity prior to transferring the unused rewards or underused reward to another entity, wherein the secondary resource of a different type of form than the unused reward or underused reward.

15. A method for enhancing distribution of resources, the method comprising:
providing for a plurality of computing devices disposed across a distributed computing network;
generating, at one or more of the computing devices, one or more resources for an entity in response to occurrence of an entity-related triggering event;
identifying, by at least one computing device processor associated with a corresponding one of the computing devices, at least one of the one or more resources that is unused or underused by the entity; and
in response to identifying the at least one unused resource or underused resource, reallocating, by at least one computing device processor associated with a corresponding one of the computing devices, the at least one unused resource or underused resource.

16. The method of claim 15, wherein reallocating further comprises converting, by a computing device processor, the at least one unused resource or underused resource to at least a portion of a secondary resource.

17. The method of claim 16, wherein converting further comprises aggregating the unused resources or underused resources prior to converting the unused resources or underused resources to the secondary resource.

18. The method of claim 15, wherein reallocating further comprises transferring, via a computing network, the unused resource or underused resource to another entity identified by the entity.

19. A computer program product for enhancing distribution of resources comprising a non-transitory computer-readable storage medium having computer-executable instructions for:
generating, at one or more of computing devices disposed across a distributed computing network, one or more resources for an entity in response to occurrence of an entity-related triggering event;
identifying at least one of the one or more resources that is unused or underused by the entity; and
in response to identifying the at least one unused resource or underused resource, reallocating the at least one unused resource or underused resource.

20. The computer program product of claim 18, wherein the instructions for reallocating the at least one unused resource or underused resource further comprise instructions for, at least one of, converting the at least one unused resource or underused resource to at least a portion of a secondary resource or transferring the least one unused resource or underused resource to another entity identified by the entity.
